(19) United States
(12) Patent Application Publication
(10) Pub. No.: US 2025/0287033 A1
(43) Pub. Date: Sep. 11, 2025

(54) Method and Apparatus for Reordering Candidates of Merge with MVD Mode in Video Coding Systems

(71) Applicant: MEDIATEK INC., Hsinchu City (TW)

(72) Inventors: Shih-Chun CHIU, Hsinchu City (TW); Chih-Wei HSU, Hsinchu City (TW); Ching-Yeh CHEN, Hsinchu City (TW); Tzu-Der CHUANG, Hsinchu City (TW); Yu-Wen HUANG, Hsinchu City (TW)

(21) Appl. No.: 18/858,998

(22) PCT Filed: Apr. 28, 2023
(86) PCT No.: PCT/CN2023/091772

§ 371 Date: Oct. 22, 2024

Related U.S. Application Data
(60) Provisional application No. 63/336,392, filed on Apr. 29, 2022.

(51) Int. Cl. H04N 19/52; H04N 19/105; H04N 19/176; H04N 19/70

(52) U.S. Cl. CPC H04N 19/52; H04N 19/105; H04N 19/176; H04N 19/70

(57) ABSTRACT

A method and apparatus for video coding are disclosed. A set of MVP candidates is determined for the current block. Member candidates in the set of MVP candidates are reordered according to template matching costs associated with the member candidates. A diversity condition is checked for a target MVP candidate pair in the reordered set, where the diversity condition comprises a target matching cost difference for the target MVP candidate pair being smaller than a first threshold from a first set of at least one pre-defined value, or a target MV difference for the target MVP candidate being smaller than a second threshold. If the diversity condition is satisfied, one of the target MVP candidate pair is moved to a later position in the reordered set of MVP candidates to form a modified-reordered set of MVP candidates. The current block is encoded or decoded by using motion information.

### CROSS REFERENCE TO RELATED APPLICATIONS

The present invention is a non-Provisional Application of and claims priority to U.S. Provisional Patent Application No. 63/336,392, filed on Apr. 29, 2022. The U.S. Provisional Patent Application is hereby incorporated by reference in its entirety.

### FIELD OF THE INVENTION

The present invention relates to video coding system using MVP (Motion Vector Prediction) coding tool. In particular, the present invention relates to the reordering of the MVP candidate set to improve the coding efficiency.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. Among various new coding tools, some coding tools relevant to the present invention are reviewed as follows. For example, Merge with MVD Mode (MMVD) technique re-uses the same merge candidates as those in VVC and a selected candidate can be further expanded by a motion vector expression method. It is desirable to develop techniques to improve processing of MMVD.

### BRIEF SUMMARY OF THE INVENTION

A method and apparatus for video coding using multiple MVP (Motion Vector Prediction) candidates are disclosed. According to the method, input data associated with a current block are received, where the input data comprise pixel data for the current block to be encoded at an encoder side or encoded data associated with the current block to be decoded at a decoder side. A set of MVP candidates is determined for the current block. Member candidates in the set of MVP candidates are reordered to form a reordered set of MVP candidates according to template matching costs associated with the member candidates, and wherein each of the template matching costs is measured between first samples in one or more first neighbouring areas of the current block and second samples in one or more second neighbouring areas of a reference block located according to each member candidate in the set of MVP candidates. A diversity condition is checked for a target MVP candidate pair in the reordered set of MVP candidates, wherein the diversity condition comprises a target matching cost difference for the target MVP candidate pair being smaller than a first threshold from a first set of at least one pre-defined value, or a target MV difference for the target MVP candidate being smaller than a second threshold. If the diversity condition is satisfied, one of the target MVP candidate pair is moved to a later position in the reordered set of MVP candidates to form a modified-reordered set of MVP candidates. The current block is encoded or decoded by using motion information comprising the modified-reordered set of MVP candidates.

In one embodiment, the set of MVP candidates is generated by adding offsets to one or more base MVs selected from a merge list, and wherein the offsets correspond to pairs from a set of steps and a set of directions.

In one embodiment, said checking the diversity condition and said moving one of the target MVP candidate pair are repeated till a maximum number of iterations is reached or all MVP candidate pairs are checked.

In one embodiment, the diversity condition corresponds to the target matching cost difference for the target MVP candidate pair being smaller than the first threshold from the first set of said at least one pre-defined value. In one embodiment, the number of the first set of said at least one pre-defined value is more than one, and the first threshold is determined according to a block size of the current block.

In one embodiment, the diversity condition corresponds to the target matching cost difference for the target MVP candidate pair being smaller than a third threshold, and the target MV difference for the target MVP candidate pair being smaller than the second threshold.

In one embodiment, the diversity condition corresponds to an average or a weighted average of the target matching cost difference and the target MV difference for the target MVP candidate pair being smaller than a fourth threshold.

In one embodiment, the thresholds mentioned above can be from a set of pre-defined values. In another embodiment, the thresholds mentioned above can be dependent on a block size of the current block. In yet another embodiment, the thresholds mentioned above can be signalled at the encoder side or parsed at the decoder side.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates an example of CPR (Current Picture Referencing) compensation, where blocks are predicted by corresponding blocks in the same picture.

FIG. 3 illustrates an example of MMVD (Merge mode Motion Vector Difference) search process, where a current block in the current frame is processed by bi-direction prediction using a L0 reference frame and a L1 reference frame.

FIG. 4 illustrates the offset distances in the horizontal and vertical directions for a L0 reference block and L1 reference block according to MMVD.

FIG. 5 illustrates an example of templates used for the current block and corresponding reference blocks to measure matching costs associated with merge candidates.

FIG. 6 illustrates an example of template and reference samples of the template for block with subblock motion using the motion information of the subblocks of the current block.

FIG. 7 illustrates a flowchart of an exemplary video coding system that utilizes reordering method according to an embodiment of the present invention to improve coding efficiency.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

### Current Picture Referencing

Motion Compensation, one of the key technologies in hybrid video coding, explores the pixel correlation between adjacent pictures. It is generally assumed that, in a video sequence, the patterns corresponding to objects or background in a frame are displaced to form corresponding objects in the subsequent frame or correlated with other patterns within the current frame. With the estimation of such displacement (e.g. using block matching techniques), the pattern can be mostly reproduced without the need to re-code the pattern. Similarly, block matching and copy has also been tried to allow selecting the reference block from the same picture as the current block. It was observed to be inefficient when applying this concept to camera captured videos. Part of the reasons is that the textual pattern in a spatial neighbouring area may be similar to the current coding block, but usually with some gradual changes over the space. It is difficult for a block to find an exact match within the same picture in a video captured by a camera. Accordingly, the improvement in coding performance is limited.

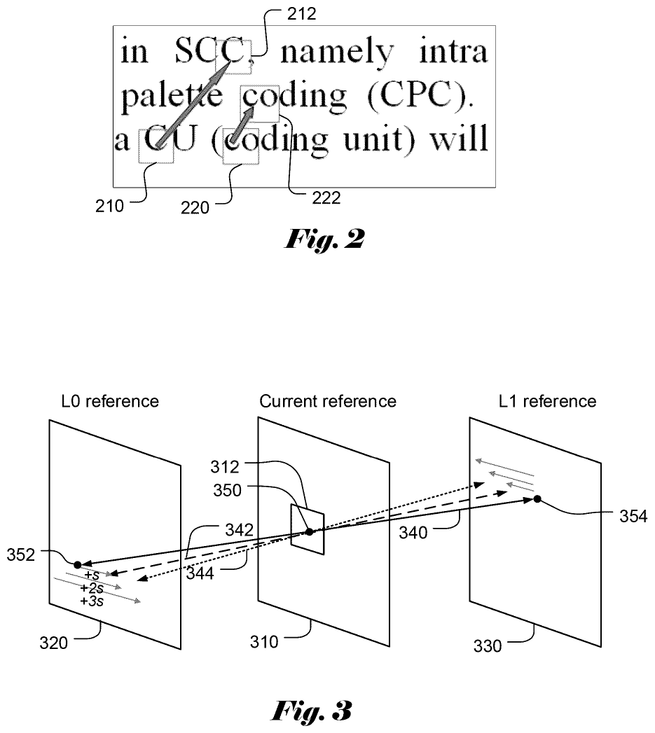

However, the situation for spatial correlation among pixels within the same picture is different for screen contents. For a typical video with texts and graphics, there are usually repetitive patterns within the same picture. Hence, intra (picture) block compensation has been observed to be very effective. A new prediction mode, i.e., the intra block copy (IBC) mode or called current picture referencing (CPR), has been introduced for screen content coding to utilize this characteristic. In the CPR mode, a prediction unit (PU) is predicted from a previously reconstructed block within the same picture. Further, a displacement vector (called block vector or BV) is used to indicate the relative displacement from the position of the current block to that of the reference block. The prediction errors are then coded using transformation, quantization and entropy coding. An example of CPR compensation is illustrated in FIG. 2, where block 212 is a corresponding block for block 210, and block 222 is a corresponding block for block 220. In this technique, the reference samples correspond to the reconstructed samples of the current decoded picture prior to in-loop filter operations, both deblocking and sample adaptive offset (SAO) filters in HEVC.

The very first version of CPR was proposed in JCTVC-M0350 (Budagavi et al., AHG8: Video coding using Intra motion compensation, Joint Collaborative Team on Video Coding (JCT-VC) of ITU-T SG16 WP3 and ISO/IEC JTC 1/SC 29/WG11, 13th Meeting: Incheon, KR, 18-26 April 2013, Document: JCTVC-M0350) to the HEVC Range Extensions (RExt) development. In this version, the CPR compensation was limited to be within a small local area, with only 1-D block vector and only for block size of 2N×2N. Later, a more advanced CPR design has been developed during the standardization of HEVC SCC (Screen Content Coding).

When CPR is used, only part of the current picture can be used as the reference picture. A few bitstream conformance constraints are imposed to regulate the valid MV value referring to the current picture. First, one of the following two must be true:

$$BV\_x + offsetX + nPbSw + xPbs - xCbs <= 0 \qquad ( 1 )$$

$$BV\_y + offsetY + nPbSh + yPbs - yCbs <= 0 \qquad ( 2 )$$

Second, the following WPP condition must be true:

$$( xPbs + BV\_x + offsetX + nPbSw - 1 ) / CtbSizeY - xCbs / CtbSizeY <= yCbs / CtbSizeY - ( yPbs + BV\_y + offsetY + nPbSh - 1 ) / CtbSizeY \qquad ( 3 )$$

In equations (1) through (3), (BV_x, BV_y) is the luma block vector (the motion vector for CPR) for the current PU; nPbSw and nPbSh are the width and height of the current PU; (xPbS, yPbs) is the location of the top-left pixel of the current PU relative to the current picture; (xCbs, yCbs) is the location of the top-left pixel of the current CU relative to the current picture; and CtbSizeY is the size of the CTU. OffsetX and offsetY are two adjusted offsets in two dimensions in consideration of chroma sample interpolation for the CPR mode.

$$offsetX = BVC\_x \& 0 \times 7 ? 2 : 0 \qquad ( 4 )$$

$$offsetY = BVC\_y \& 0 \times 7 ? 2 : 0 \qquad ( 5 )$$

(BVC_x, BVC_y) is the chroma block vector, in ⅛-pel resolution in HEVC.

Third, the reference block for CPR must be within the same tile/slice boundary.

Merge with MVD Mode (MMVD) Technique

The MMVD technique is proposed in JVECT-J0024. MMVD is used for either skip or merge modes with a proposed motion vector expression method. MMVD re-uses the same merge candidates as those in VVC. Among the merge candidates, a candidate can be selected, and is further expanded by the proposed motion vector expression method. MMVD provides a new motion vector expression with simplified signalling. The expression method includes prediction direction information, starting point (also referred as a base in this disclosure), motion magnitude (also referred as a distance in this disclosure), and motion direction. FIG. 3 illustrates an example of MMVD search process, where a current block 312 in the current frame 310 is processed by bi-direction prediction using a L0 reference frame 320 and a L1 reference frame 330. A pixel location 350 is projected to pixel location 352 in L0 reference frame 320 and pixel location 354 in L1 reference frame 330. According to the MMVD search process, updated locations will be searched by adding offsets in selected directions. For example, the updated locations correspond to locations along line 342 or 344 in the horizontal direction with distances to at s, 2 s or 3 s.

This proposed technique uses a merge candidate list as is. However, only candidates which are default merge type (i.e., MRG_TYPE_DEFAULT_N) are considered for MMVD's expansion. Prediction direction information indicates a prediction direction among L0, L1, and L0 and L1 predictions. In B slice, the proposed method can generate bi-prediction candidates from merge candidates with uni-prediction by using mirroring technique. For example, if a merge candidate is uni-prediction with L1, a reference index of L0 is decided by searching a reference picture in list 0, which is mirrored with the reference picture for list 1. If there is no corresponding picture, the nearest reference picture to the current picture is used. L0′ MV is derived by scaling L1's MV and the scaling factor is calculated by POC distance.

In MMVD, after a merge candidate is selected, it is further expanded or refined by the signalled MVDs information. The further information includes a merge candidate flag, an index to specify motion magnitude, and an index for indication of the motion direction. In MMVD mode, one of the first two candidates in the merge list is selected to be used as an MV basis. The MMVD candidate flag is signalled to specify which one is used between the first and second merge candidates. The initial MVs (i.e., merge candidates) selected from the merge candidate list are also referred as bases in this disclosure. After searching the set of locations, a selected MV candidate is referred as an expanded MV candidate in this disclosure.

If the prediction direction of the MMVD candidate is the same as one of the original merge candidate, the index with value 0 is signalled as the MMVD prediction direction. Otherwise, the index with value 1 is signalled. After sending first bit, the remaining prediction direction is signalled based on the pre-defined priority order of MMVD prediction direction. Priority order is L0/L1 prediction, L0 prediction and L1 prediction. If the prediction direction of merge candidate is L1, signalling ‘0’ indicates MMVD′ prediction direction as L1. Signalling ‘10’ indicates MMVD′ prediction direction as L0 and L1. Signalling ‘11’ indicates MMVD′ prediction direction as L0. If L0 and L1 prediction lists are same, MMVD's prediction direction information is not signalled.

Base candidate index, as shown in Table 1, defines the starting point. Base candidate index indicates the best candidate among candidates in the list as follows.

TABLE 1
Base candidate IDX

| Base candidate IDX | 0 | 1 | 2 | 3 |
|---|---|---|---|---|
| Nth MVP | 1st MVP | 2nd MVP | 3rd MVP | 4th MVP |

Distance index specifies motion magnitude information and indicates the pre-defined offset from the starting points (412 and 422) for a L0 reference block 410 and L1 reference block 420 as shown in FIG. 4. In FIG. 4, an offset is added to either the horizontal component or the vertical component of the starting MV, where small circles in different styles correspond to different offsets from the centre. The relation between the distance index and pre-defined offset is specified in Table 2.

TABLE 2
Distance IDX

| Distance IDX | 0 | 1 | 2 | 3 | 4 | 5 | 6 | 7 |
|---|---|---|---|---|---|---|---|---|
| Pixel | ¼- | ½- | 1- | 2- | 4- | 8- | 16- | 32- |
| distance | pel | pel | pel | pel | pel | pel | pel | pel |

Direction index represents the direction of the MVD relative to the starting point. The direction index can represent of the four directions as shown below. Direction index represents the direction of the MVD relative to the starting point. The direction index can represent the four directions as shown in Table 3. It is noted that the meaning of MVD sign could be variant according to the information of starting MVs. When the starting MVs are an un-prediction MV or bi-prediction MVs with both lists pointing to the same side of the current picture (i.e. POCs of two references both larger than the POC of the current picture, or both smaller than the POC of the current picture), the sign in Table 3 specifies the sign of the MV offset added to the starting MV. When the starting MVs are bi-prediction MVs with the two MVs pointing to the different sides of the current picture (i.e. the POC of one reference larger than the POC of the current picture, and the POC of the other reference smaller than the POC of the current picture), and the difference of POC in list 0 is greater than the one in list 1, the sign in Table 3 specifies the sign of MV offset added to the list0 MV component of the starting MV and the sign for the list1 MV has an opposite value. Otherwise, if the difference of POC in list 1 is greater than list 0, the sign in Table 3 specifies the sign of the MV offset added to the list1 MV component of starting MV and the sign for the list0 MV has an opposite value.

TABLE 3
Direction IDX

| Direction IDX | 00 | 01 | 10 | 11 |
|---|---|---|---|---|
| x-axis | + | − | N/A | N/A |
| y-axis | N/A | N/A | + | − |

To reduce the encoder complexity, block restriction is applied. If either width or height of a CU is less than 4, MMVD is not performed.

Adaptive Reordering of Merge Candidates with Template Matching (ARMC-TM)

The merge candidates are adaptively reordered according to costs evaluated using template matching (TM). The reordering method can be applied to the regular merge mode, template matching (TM) merge mode, and affine merge mode (excluding the SbTMVP candidate). For the TM merge mode, merge candidates are reordered before the refinement process.

After a merge candidate list is constructed, merge candidates are divided into multiple subgroups. The subgroup size is set to 5 for the regular merge mode and TM merge mode. The subgroup size is set to 3 for the affine merge mode. Merge candidates in each subgroup are reordered ascendingly according to cost values based on template matching. For ARMC-TM, the candidates in a subgroup are skipped if the subgroup satisfies the following 2 conditions: (1) the subgroup is the last subgroup and (2) the subgroup is not the first subgroup. For simplification, merge candidates in the last but not the first subgroup are not reordered.

The template matching cost of a merge candidate is measured as the sum of absolute differences (SAD) between samples of a template of the current block and their corresponding reference samples. The template comprises a set of reconstructed samples neighbouring to the current block. Reference samples of the template are located by the motion information of the merge candidate.

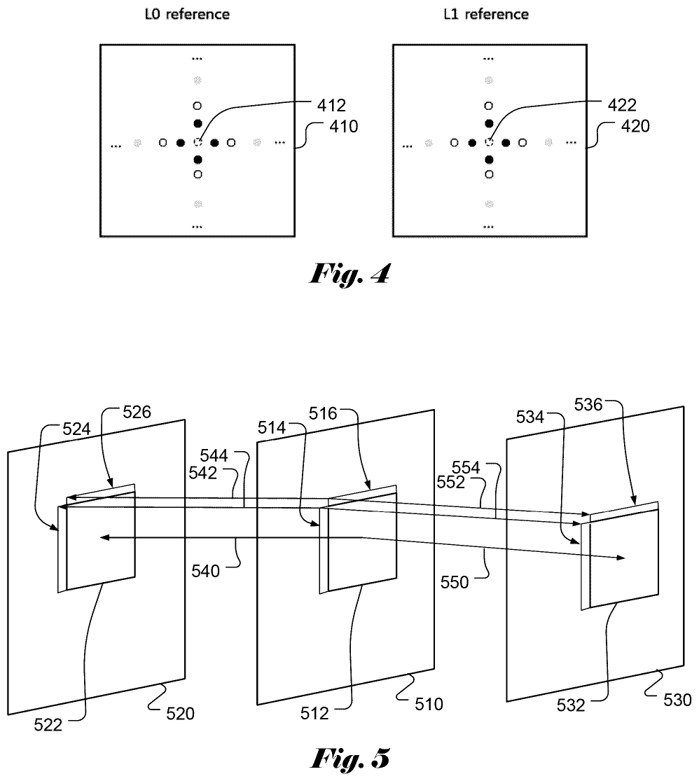

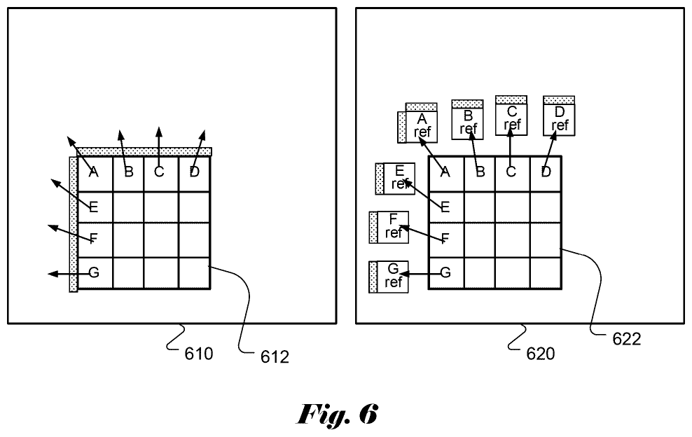

When a merge candidate utilizes bi-directional prediction, the reference samples of the template of the merge candidate are also generated by bi-prediction as shown in FIG. 5. In FIG. 5, block 512 corresponds to a current block in current picture 510, blocks 522 and 532 correspond to reference blocks in reference pictures 520 and 530 in list 0 and list 1 respectively. Templates 514 and 516 are for current block 512, templates 524 and 526 are for reference block 522, and templates 534 and 536 are for reference block 532. Motion vectors 540, 542 and 544 are merge candidates in list 0 and motion vectors 550, 552 and 554 are merge candidates in list 1.

For subblock-based merge candidates with subblock size equal to Wsub×Hsub, the above template comprises several sub-templates with the size of Wsub×1, and the left template comprises several sub-templates with the size of 1×Hsub. As shown in FIG. 6, the motion information of the subblocks in the first row and the first column of current block is used to derive the reference samples of each sub-template. In FIG. 6, block 612 corresponds to a current block in current picture 610 and block 622 corresponds to a collocated block in reference picture 620. Each small square in the current block and the collocated block corresponds to a subblock. The dot-filled areas on the left and top of the current block correspond to template for the current block. The boundary subblocks are labelled from A to G. The arrow associated with each subblock corresponds to the motion vector of the subblock. The reference subblocks (labelled as Aref to Gref) are located according to the motion vectors associated with the boundary subblocks.

### Multi-Hypothesis Prediction (MH) Technique

Multi-hypothesis prediction is proposed to improve the existing prediction modes in inter pictures, including uni-prediction of advanced motion vector prediction (AMVP) mode, skip and merge mode, and intra mode. The general concept is to combine an existing prediction mode with an extra merge indexed prediction. The merge indexed prediction is performed in a manner the same as that for the regular merge mode, where a merge index is signalled to acquire motion information for the motion compensated prediction. The final prediction is the weighted average of the merge indexed prediction and the prediction generated by the existing prediction mode, where different weights are applied depending on the combinations. Detail information can be found in JVET-K1030 (Chih-Wei Hsu, et al., Description of Core Experiment 10: Combined and multi-hypothesis prediction, Joint Collaborative Team on Video Coding (JCT-VC) of ITU-T SG16 WP3 and ISO/IEC JTC 1/SC 29/WG11, 11th Meeting: Ljubljana, SI, 10-18 Jul. 2018, Document: JVET-K1030), or JVET-L0100 (Man-Shu Chiang, et al., CE10.1.1: Multi-hypothesis prediction for improving AMVP mode, skip or merge mode, and intra mode, Joint Collaborative Team on Video Coding (JCT-VC) of ITU-T SG16 WP3 and ISO/IEC JTC 1/SC 29/WG11, 12th Meeting: Macao, CN, 3-12 Oct. 2018, Document: JVET-L0100).

### Improvement of Reordering Algorithm Based on Template Matching

In TM-based reordering algorithms, the sum of absolute differences (SAD) or other distortion metrics between samples of a template of the current block and their corresponding reference samples are calculated as the TM costs, and corresponding candidates are reordered ascendingly according to the TM costs. However, such algorithm may result in some identical candidates with close reordered indices, which is redundant and leads to codeword waste. Therefore, the following methods are proposed to resolve the problem.

In one method, after the reordering, the TM cost differences between any two subsequent candidates are checked. If the minimum cost difference is smaller than a threshold, one of the corresponding candidates is moved to a later position in the reordered list. The minimum cost difference checking and the candidate moving are repeated until a maximum number of iterations is reached or the minimum cost difference is no longer smaller than a threshold. In one embodiment, the threshold is a pre-determined value. In another embodiment, the threshold is determined by CU size. In another embodiment, the threshold is explicitly signaled to the decoder side. The reordering process disclosed here can be applications where a set of MVP candidates are involved. For example, the present invention can be applied to MMVD. After reordering, embodiments according to the present invention check for closely related MVP candidate pair since the close similarity as measured by the TM matching cost indicate such MVP candidate pair may have certain degree of redundancy. Therefore, embodiments according to the present invention move one of the MVP candidate pair to a later position in the reordered list.

In another method, after the reordering, the TM cost differences and the MV differences between any two subsequent candidates are checked. If there is a candidate pair with the cost difference smaller than a first threshold and the MV difference smaller than a second threshold, one of the two candidates is moved to a later position in the reordered list. The cost and MV difference checking and candidate moving are repeated until a maximum number of iterations is reached or all subsequent candidate pairs satisfy the cost and MV difference checking conditions. Similar to the previous method, the two thresholds can be pre-determined values, values related to CU size, or explicitly-signaled values.

In another method, after the reordering, a diversity cost between any two subsequent candidates is calculated by taking the average or the weighted average of the TM cost differences and the MV differences. According to this method, both the TM cost differences and the MV differences are taken into account for deciding whether to move one of the candidate pair to a later position in the reordered list. If the minimum diversity cost is smaller than a threshold, one of the corresponding candidates is moved to a later position in the reordered list. The minimum diversity cost checking and the candidate moving are repeated until a maximum number of iterations is reached or the minimum diversity cost is no longer smaller than a threshold. Similar to the previous methods, the threshold can be a pre-determined value, a value related to CU size, or an explicitly-signaled value.

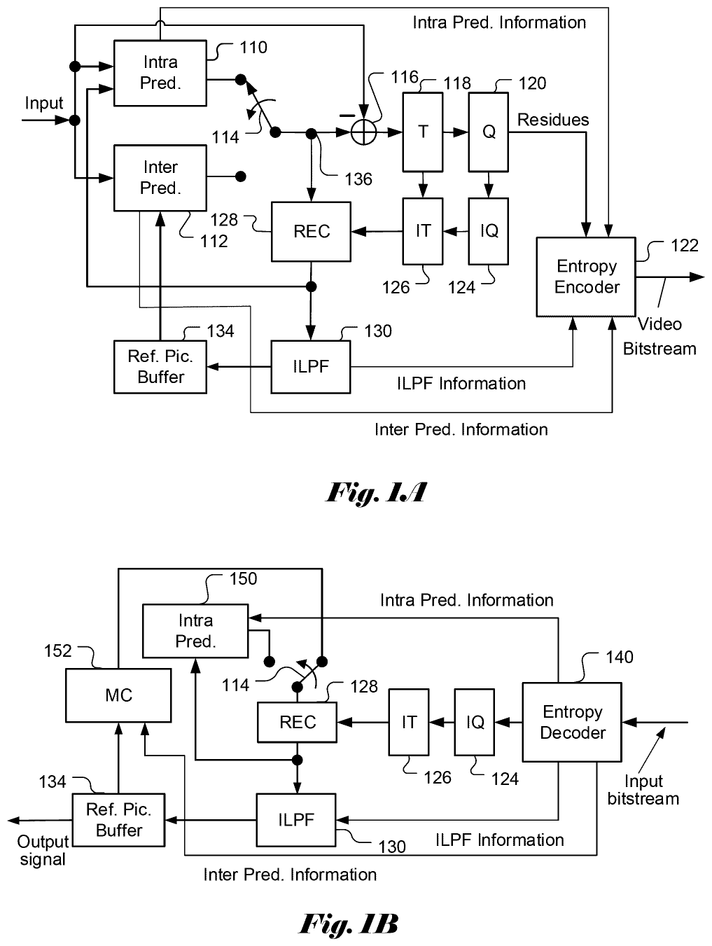

Any of the MVP reordering methods based on template matching described above can be implemented in encoders and/or decoders. For example, any of the proposed methods can be implemented in an inter coding module of an encoder (e.g. Inter Pred. 112 in FIG. 1A), a motion compensation module (e.g., MC 152 in FIG. 1B), a merge candidate derivation module of a decoder. Alternatively, any of the proposed methods can be implemented as a circuit coupled to the inter coding module of an encoder and/or motion compensation module, a merge candidate derivation module of the decoder. While the Inter-Pred. 112 and MC 152 are shown as individual processing units to support the MMVD methods, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

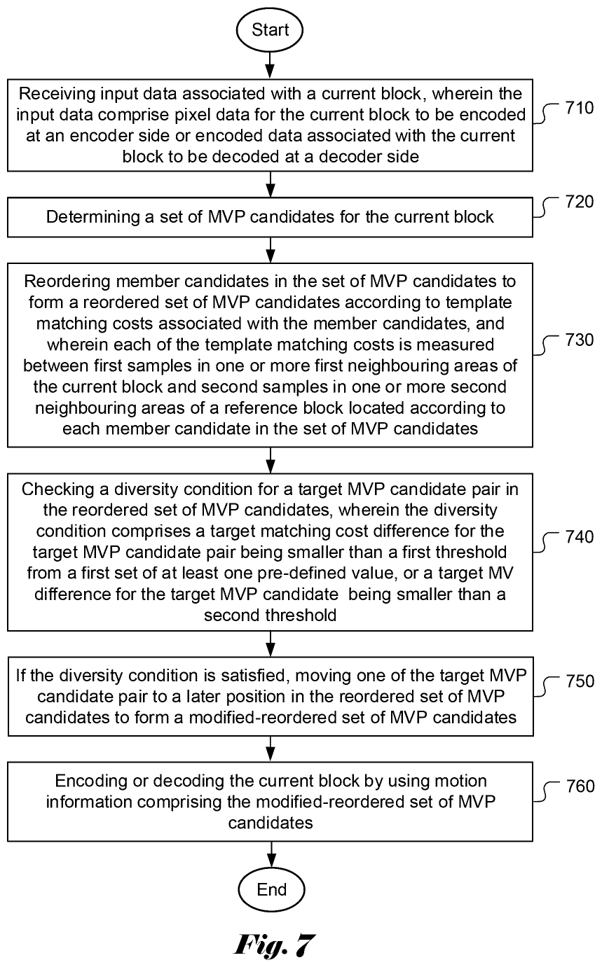

FIG. 7 illustrates a flowchart of an exemplary video coding system that utilizes reordering method according to an embodiment of the present invention to improve coding efficiency. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block are received in step 710, wherein the input data comprise pixel data for the current block to be encoded at an encoder side or prediction residual data associated with the current block to be decoded at a decoder side. A set of MVP candidates is determined for the current block in step 720. Member candidates in the set of MVP candidates are reordered to form a reordered set of MVP candidates according to template matching costs associated with the member candidates in step 730, and wherein each of the template matching costs is measured between first samples in one or more first neighbouring areas of the current block and second samples in one or more second neighbouring areas of a reference block located according to each member candidate in the set of MVP candidates. A diversity condition is checked for a target MVP candidate pair in the reordered set of MVP candidates in step 740, wherein the diversity condition comprises a target matching cost difference for the target MVP candidate pair being smaller than a first threshold from a first set of at least one pre-defined value, or a target MV difference for the target MVP candidate being smaller than a second threshold. If the diversity condition is satisfied, one of the target MVP candidate pair is moved to a later position in the reordered set of MVP candidates to form a modified-reordered set of MVP candidates in step 750. The current block is encoded or decoded by using motion information comprising the modified-reordered set of MVP candidates in step 760.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding using MVP (Motion Vector Prediction), the method comprising:
receiving input data associated with a current block, wherein the input data comprise pixel data for the current block to be encoded at an encoder side or encoded data associated with the current block to be decoded at a decoder side;
determining a set of MVP candidates for the current block;
reordering member candidates in the set of MVP candidates to form a reordered set of MVP candidates according to template matching costs associated with the member candidates, and wherein each of the template matching costs is measured between first samples in one or more first neighbouring areas of the current block and second samples in one or more second neighbouring areas of a reference block located according to each member candidate in the set of MVP candidates;
checking a diversity condition for a target MVP candidate pair in the reordered set of MVP candidates, wherein the diversity condition comprises a target matching cost difference for the target MVP candidate pair being smaller than a first threshold from a first set of at least one pre-defined value, or a target MV difference for the target MVP candidate being smaller than a second threshold;
if the diversity condition is satisfied, moving one of the target MVP candidate pair to a later position in the reordered set of MVP candidates to form a modified-reordered set of MVP candidates; and
encoding or decoding the current block by using motion information comprising the modified-reordered set of MVP candidates.

2. The method of claim 1, wherein the set of MVP candidates is generated by adding offsets to one or more base MVs selected from a merge list, and wherein the offsets correspond to pairs from a set of steps and a set of directions.

3. The method of claim 1, wherein said checking the diversity condition and said moving one of the target MVP candidate pair are repeated till a maximum number of iterations is reached or all MVP candidate pairs are checked.

4. The method of claim 1, wherein the diversity condition corresponds to the target matching cost difference for the target MVP candidate pair being smaller than the first threshold from the first set of said at least one pre-defined value.

5. The method of claim 4, wherein a number of the first set of said at least one pre-defined value is more than one, and the first threshold is determined according to a block size of the current block.

6. The method of claim 4, wherein the first threshold is signalled at the encoder side or parsed at the decoder side.

7. The method of claim 1, wherein the diversity condition corresponds to the target matching cost difference for the target MVP candidate pair being smaller than a third threshold, and the target MV difference for the target MVP candidate pair being smaller than the second threshold.

8. The method of claim 7, wherein the second threshold is from a second set of pre-defined values or the third threshold is from a third set of pre-defined values.

9. The method of claim 8, wherein the second threshold or the third threshold is dependent on a block size of the current block.

10. The method of claim 8, wherein the second threshold or the third threshold is signalled at the encoder side or parsed at the decoder side.

11. The method of claim 1, wherein the diversity condition corresponds to an average or a weighted average of the target matching cost difference and the target MV difference for the target MVP candidate pair being smaller than a fourth threshold.

12. The method of claim 11, wherein the fourth threshold is from a fourth set of pre-defined values.

13. The method of claim 12, wherein the fourth threshold is dependent on a block size of the current block.

14. The method of claim 12, wherein the fourth threshold is signalled at the encoder side or parsed at the decoder side.

15. An apparatus for video coding using MVP (Motion Vector Prediction), the apparatus comprising one or more electronics or processors arranged to:
receive input data associated with a current block, wherein the input data comprise pixel data for the current block to be encoded at an encoder side or prediction residual data associated with the current block to be decoded at a decoder side;
determine a set of MVP candidates for the current block;
reorder member candidates in the set of MVP candidates to form a reordered set of MVP candidates according to template matching costs associated with the member candidates, and wherein each of the template matching costs is measured between first samples in one or more first neighbouring areas of the current block and second samples in one or more second neighbouring areas of a reference block located according to each member candidate in the set of MVP candidates;
check a diversity condition for a target MVP candidate pair in the reordered set of MVP candidates, wherein the diversity condition comprises a target matching cost difference for the target MVP candidate pair is smaller than a first threshold from a first set of pre-defined values, or a target MV difference for the target MVP candidate pair is smaller than a second threshold;
if the diversity condition is satisfied, move one of the target MVP candidate pair to a later position in the reordered set of MVP candidates to form a modified-reordered set of MVP candidates; and
encode or decode the current block by using motion information comprising the modified-reordered set of MVP candidates.
